(19) United States
(12) Patent Application Publication
(10) Pub. No.: US 2012/0293154 A1
(43) Pub. Date: Nov. 22, 2012

(54) GENERATION OF A TEMPERATURE-STABLE VOLTAGE REFERENCE

(75) Inventors: Anass Samir, Marseille (FR); Bruno Gailhard, Rognes (FR)

(73) Assignee: STMICROELECTRONICS (ROUSSET) SAS, Rousset (FR)

(21) Appl. No.: 13/475,703

(22) Filed: May 18, 2012

(30) Foreign Application Priority Data
May 20, 2011 (FR) 1154408

(51) Int. Cl. G05F 3/02

(52) U.S. Cl. 323/313

(57) ABSTRACT

A circuit for generating a temperature-stable reference voltage, including, between two terminals of application of a D.C. voltage: a current source and at least two parallel branches, each comprising a resistive element and one or several transistors, the transistors being different form one another and the reference voltage being sampled between the terminals of said branches.

### BACKGROUND

1. Technical Field

The present disclosure generally relates to electronic circuits and, more specifically, to the generation of a temperature-stable reference voltage within an electronic circuit.

2. Description of the Art

Many reference voltage generation circuits aiming at being temperature-stable to provide a voltage reference to electronic circuits are known. Such reference voltages have multiple applications, for example, analog-to-digital and digital-to-analog converters, circuits for generating voltage thresholds for the switching of logic circuits, etc.

Reference voltages can be generated in a relatively accurate manner. However, a limitation of existing circuits is that the reference voltage is techno-dependent, that is, the value of the generated voltage depends on the basic component (bipolar transistor or MOS transistor) used. To exploit the reference voltage thus generated, its value then typically is lowered, for example, by resistive means and by using amplifiers, which adversely affects the consumption. Further, this deteriorates the sensitivity of the reference voltage towards variations of the power supply voltage (deterioration of the power supply rejection ratio (PSRR)).

### BRIEF SUMMARY

One embodiment of the disclosure is a circuit for generating a temperature-stable reference voltage which overcomes all or part of the disadvantages of current circuits.

One embodiment of the disclosure is a circuit for generating a reference voltage having a value that can be set when designing the circuit.

One embodiment of the disclosure is a particularly simple method for sizing a circuit for generating a reference voltage.

One embodiment provides a circuit for generating a temperature-stable voltage, comprising, between two terminals of application of a D.C. voltage:

a current source; and

at least two parallel branches, each comprising a resistive element and one or several transistors, the transistors being different from one another and the reference voltage being sampled between the terminals of said branches.

According to an embodiment, each transistor is selected from among a PNP bipolar transistor, an N-channel MOS transistor, and a P-channel MOS transistor.

According to an embodiment, the MOS transistors are selected according to their gate oxide and channel doping thickness, according to the desired reference voltage.

According to an embodiment, the resistance values and the ratio between these values are selected according to the desired reference voltage.

According to an embodiment, the reference voltage takes, according to the transistors and to the resistors, a value ranging between 550 millivolts and 1.2 volt.

According to an embodiment, at least one transistor of one of the branches is an N- or P-channel MOS transistor and at least one transistor of the other branch is a PNP-type bipolar transistor.

According to an embodiment, at least one transistor of one of the branches is an N- or P-channel MOS transistor and at least one transistor of the other branch is an N- or P-channel MOS transistor.

According to an embodiment, the circuit comprises two and only two branches.

Another embodiment provides a method for sizing a circuit for generating a reference voltage such as discussed hereabove, wherein values Ra and Rb of the resistances are selected to comply with the following relations:

$${V}_{REF} = \frac{( 1 + α \cdot β )}{2} \cdot Ra \cdot Ia + \frac{Va + Vb}{2} ; and$$

$${V}_{REF} = \frac{1}{2} ( 1 + \frac{1}{α \cdot β} ) \cdot Rb \cdot Ib + \frac{Va + Vb}{2} ,$$

where Va and Vb stand for the respective voltages across the transistor(s) respectively in series with the resistors of values Ra and Rb, where Ia and Ib stand for the respective values of the currents in the resistors of values Ra and Rb, and where and are the respective ratios between values Ib and Ia and between values Rb and Ra.

The foregoing and other features, and advantages will be discussed in detail in the following non-limiting description of specific embodiments in connection with the accompanying drawings.

### BRIEF DESCRIPTION OF THE SEVERAL VIEWS OF THE DRAWINGS

FIG. 1 is a block diagram illustrating an electronic system according to one embodiment;

FIG. 2A shows a first prior art circuit for generating a temperature-stable reference voltage;

FIG. 2B illustrates the voltage obtained with the circuit of FIG. 2A;

FIG. 3A shows a second prior art circuit for generating a temperature-stable reference voltage;

FIG. 3B illustrates the voltage obtained with the circuit of FIG. 3A;

FIG. 4 schematically shows in the form of blocks an embodiment of a circuit for generating a temperature-stable reference voltage;

FIG. 5 is an electric diagram of a first embodiment of the circuit of FIG. 4; and

FIG. 6 is an electric diagram of a second embodiment of the circuit of FIG. 4.

### DETAILED DESCRIPTION

The same elements have been designated with the same reference numerals in the different drawings. For clarity, only those elements which are useful to the understanding of the described embodiments have been shown and will be detailed. In particular, the destination of the voltage generated by the circuit has not been detailed, the described embodiments being compatible with all usual applications of reference voltage generation circuits.

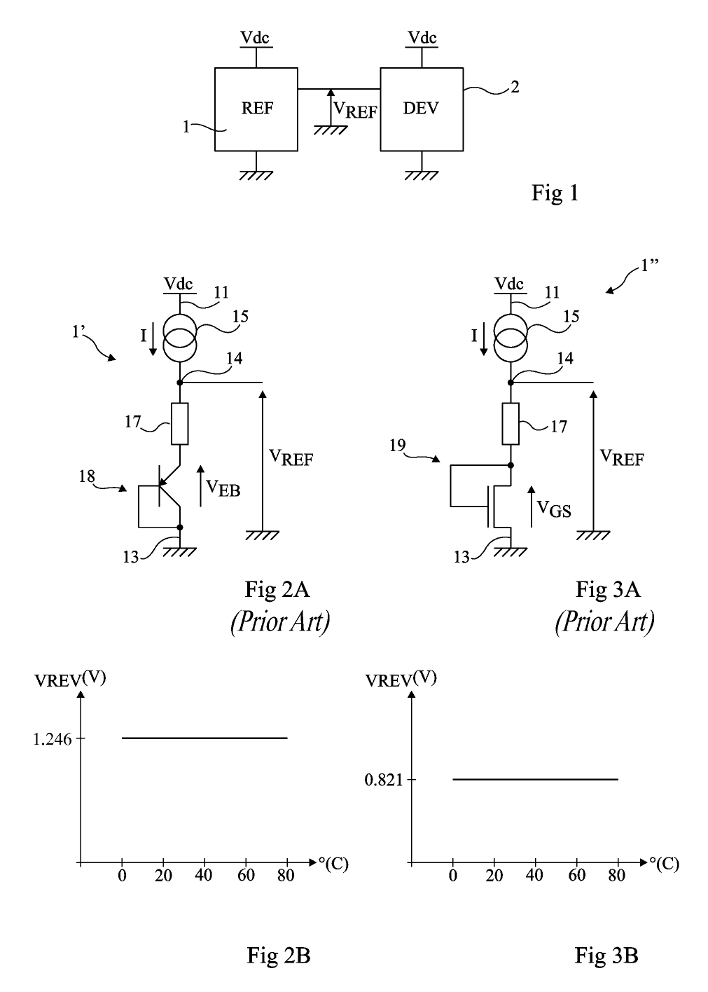

FIG. 1 is a block diagram of an example of an electronic system according to one embodiment. The circuit of FIG. 1 is powered by a D.C. voltage Vdc. This voltage is provided to a circuit 1 (REF) for generating a reference voltage VREF that is supplied to an electronic device 2 (DEV). In the example, circuit 2 is powered by the same voltage Vdc, but the power supply voltage of circuit 2 may be different from the power supply voltage of circuit 1. Circuit 1 generates a temperature-stable reference voltage to be used by one or several circuits of device 2. If desired, several reference voltages may be generated by different circuits 1.

FIG. 2A is an electric diagram of a prior art bipolar circuit 1′ for generating a reference voltage VREF. This circuit comprises, coupled between a terminal 11 of application of D.C. voltage Vdc and a terminal 13 of application of a reference voltage (generally the ground), a current source 15, a resistive element 17, and a PNP bipolar transistor 19. The base and the collector of the PNP transistor are interconnected to terminal 13 so that said transistor is diode-assembled. Voltage VREF is sampled between constant current source 15 and resistor 17 (terminal 14).

Circuit 1′ operates as follows. Assuming that source 15 provides a current I proportional to absolute temperature (PTAT), the reference voltage is provided by relation VREF=R*I+VEB, where VEB designates the base-emitter voltage drop of transistor 19 and R designates the value of resistive element 17. In the above relation, term R*I is proportional to temperature while term VEB is inversely proportional to temperature. These two variations compensate for each other to provide a temperature-stable reference voltage VREF. In practice, current source 15 is formed by an assembly based on transistors, typically a current mirror. Values R and I are selected so that product R*I is precisely equal to voltage VEB, failing which the temperature compensation is not stable.

FIG. 2B illustrates the variation of the value of voltage VREF (in volts) according to temperature (in degrees Celsius). This voltage is stable and has, for example, an accurate value of 1.246 volts for the type of technology used in the design. This value of VREF may vary between 1.21 volts and 1.25 volts according to the technology used.

When a low source current I is used, a resistor of strong value is used, and conversely. The values of resistance R and of current I are selected according to the desired current consumption and to the authorized silicon surface area.

FIG. 3A illustrates another conventional example of a reference voltage generation circuit 1″. Like for the circuit of FIG. 2A, a current source 15 is coupled with a resistive element 17 and a transistor 19 between two terminals 11 and 13 of application of a D.C. voltage Vdc. In the example of FIG. 3A, transistor 19 is an N-channel MOS transistor having its gate and its drain interconnected. The value of voltage VREF sampled from terminal 14 representing the interconnection of current source 15 with resistor 17 is provided by the following relation:

VREF=R*I+VGS.

In the above relation, term R*I is proportional to temperature while term VGS is inversely proportional to temperature. These two variations compensate for each other to provide a temperature-stable reference voltage VREF.

FIG. 3B illustrates the value of the reference voltage in volts according to temperature. It can be seen that this voltage is stable and has, in the example, a value of 0.821 volt. This value depends on the type of MOS transistor and on the technology used.

In current circuits, one or the others of the MOS or bipolar technologies are selected for the main reference voltage generation transistor according to the voltage level desired for the device. Indeed, this voltage is not adjustable.

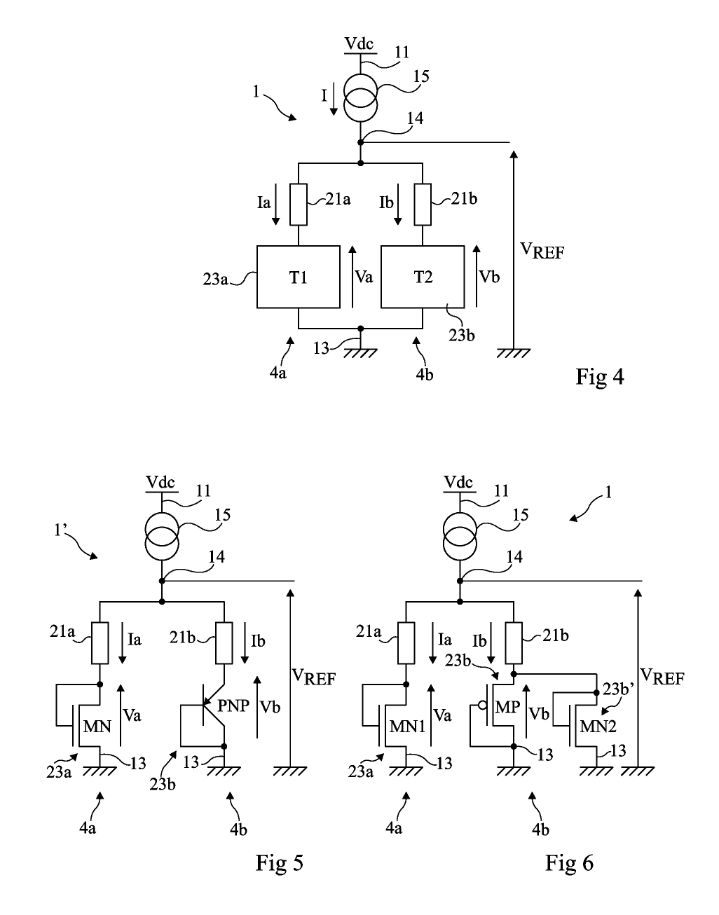

FIG. 4 is a block diagram of an embodiment of a circuit 1 for generating a reference voltage VREF.

As previously, such a circuit is powered by a D.C. voltage Vdc between two terminals 11 and 13 and uses a constant current source 15 providing a current I. However, between terminal 14 and terminal 13, two branches 4a and 4b are provided in parallel, respectively comprising a resistive element 21a of value Ra provided in series with a transistor 23a (T1), and a resistive element 21b of value Rb provided in series with a transistor 23b (T2).

Transistors T1 and T2 are selected to be different from each other, from among a PNP transistor, an N-channel MOS transistor, a P-channel MOS transistor, the MOS transistors having their gates formed in oxide levels of variable thickness, generally designated as GO1 and GO2. The difference between gate oxide thicknesses is linked to the forming of the electronic circuit in which high-voltage and low-voltage MOS transistors (relatively to each other) are generally provided. This gate oxide thickness difference between transistors modifies their threshold voltage Vt and thus their gate-source voltage VGS.

In the technology taken as an example, the gate oxides GO1 and GO2 of the MOS transistors can be differentiated by their gate oxide thickness Tox as follows:
GO1 1.2V: Tox˜21 A°
GO1 1.8V: Tox˜35 A°
GO2 3.3V: Tox˜65 A°.

In addition, either or both of the transistors can be HV (for high voltage) transistors, for example with a threshold voltage Vt of 5V and a gate oxide thickness Tox˜200 A°.

Among the MOS transistors, there also exist several transistors of different voltages Vt due to a different channel doping.

Respective values Ra and Rb of resistors 21a and 21b are specifically selected to obtain a temperature-stable reference by taking into account the nature of transistors T1 and T2 selected for branches 4a and 4b. Transistors T1 and T2 are, whatever the selected nature, diode-assembled (with their gate and drain interconnected for MOS transistors and their base and collector interconnected for bipolar transistors).

Calling Ia and Ib the respective currents in branches 4a and 4b (in resistors Ra and Rb) and Vb and Va the respective voltages across transistors T1 and T2, the following relations may be written:

Ib=αIa;

Rb=βRa;

I=Ia+Ib=(1+α)Ia=(1+1/α)Ib.

From the above relations, an expression of reference voltage VREF can be deduced as follows:

$${V}_{REF} = \frac{( 1 + α \cdot β )}{2} \cdot Ra \cdot Ia + \frac{Va + Vb}{2} ; \qquad ( 1 )$$

or again

$${V}_{REF} = \frac{1}{2} ( 1 + \frac{1}{α \cdot β} ) \cdot Rb \cdot Ib + \frac{Va + Vb}{2} . \qquad ( 2 )$$

In the above expressions, the first term is proportional to temperature while the second term is inversely proportional to temperature. It is thus not necessary to comply, for each branch, with equality Va=Ra*Ia and Vb=Rb*Ib.

By exploiting these relations, it is now possible to design a circuit for generating a reference voltage having a value that can be selected from a relatively wide range (typically approximately from 550 millivolts to 1.2 volt). This provides the designer of the electronic circuit with a considerable flexibility by enabling him to generate a temperature-stable reference voltage at a value that he chooses, while using a same basic circuit.

FIG. 5 shows a first example of a reference voltage generation circuit 1 in accordance with the circuit of FIG. 4.

Transistor T1 of branch 4a is an N-channel MOS transistor MN and transistor T2 of branch 4b is a PNP-type bipolar transistor.

The application of formulas 1 and 2 expressed in relation with FIG. 4 provides, for the circuit of FIG. 5, the following expression:

$${V}_{REF} = \frac{( 1 + α \cdot β )}{2} \cdot Ra \cdot Ia + \frac{{V}_{EB} + {V}_{GS}}{2} ; \qquad ( 3 )$$

or again

$${V}_{REF} = \frac{1}{2} ( 1 + \frac{1}{α \cdot β} ) \cdot Rb \cdot Ib + \frac{{V}_{EB} + {V}_{GS}}{2} . \qquad ( 4 )$$

Voltages VEB and VGS are known according to the technology used. Accordingly, by selecting the ratios between resistors Ra and Rb, the value of the reference voltage can be selected.

As a specific embodiment, by selecting a resistor 21b of value Rb which is twice the value Ra of resistor 21a having a 640-kiloohm value, a reference voltage of 996 millivolts is obtained.

According to another example, by selecting identical values Ra and Rb, equal to 570 kiloohms, a 1.06-volt reference voltage is obtained.

According to still another example, by selecting a value Rb of resistor 21b corresponding to half value Ra of resistor 21a and equal to 520 kiloohms, a 1.12-volt reference voltage is obtained.

In the specific examples given hereabove, the N-channel MOS transistor is assumed to be formed with a high-voltage gate oxide (relatively thick).

FIG. 6 shows the electric diagram of another embodiment of a circuit 1 in which transistors 23a and 23b respectively are an N-channel MOS transistor MN1 and a P-channel MOS transistor MP and wherein an additional N-channel MOS transistor 23b′ MN2 is in parallel with transistor 23. For example, transistor 23a has a gate oxide GO1 (1.2 V), transistor 23b has a gate oxide GO2, and transistor 23b′ has a gate oxide GO2.

The fact of providing two transistors 23b and 23b′ in parallel enables to decrease variations due to the manufacturing process. A similar solution may be envisaged on each branch.

The application of formulas (1) and (2) expressed in relation with FIG. 4 provides, for the circuit of FIG. 6, the following formulas:

$${V}_{REF} = \frac{1}{2} ( 1 + \frac{1}{α \cdot β} ) Rb \cdot Ib + \frac{{V}_{GSN 1} + {V}_{SGP}}{2} ; \qquad ( 5 )$$

or again

$${V}_{REF} = \frac{( 1 + α \cdot β )}{2} \cdot Ra \cdot Ia + \frac{{V}_{GSN 1} + {V}_{SGP}}{2} \qquad ( 6 )$$

where VGSN1 stands for the gate-source voltage of N-channel transistor MN1 and VSGP stands for the source-gate voltage of P-channel transistor MP.

As a specific example, a circuit of the type in FIG. 6 in which N-channel MOS transistor MN1 (GO1) has its gate formed with a relatively thin oxide, and N-channel MOS transistor MN2 (GO2) and P-channel transistor MP (GO2) have their gates formed with a relatively thick oxide, a reference voltage on the order of 650 millivolts can be obtained with equal resistance values Ra and Rb.

The provided electronic circuit and its two parallel branches, each comprising one or several different transistors, enables to provide an electronic designer with reference voltages of different values that he can select by sizing the circuit. In a line production of the electronic circuits, the resistance values and the transistor natures are set.

Various embodiments have been described, various alterations, modifications, and improvements will occur to those skilled in the art. In particular, the selection of the ratios between resistances, of their values, and of the transistors (and thus of the gate-source or base-emitter voltages) is within the abilities of those skilled in the art based on the functional indications given hereabove and on the desired reference voltage. One or several branches may be added in parallel with the two branches of the above circuit, each formed of a resistor and of one or several transistors. It will however be preferred to only provide two branches (each having a single resistor and one or several transistors). Indeed, this is generally sufficient to generate all the desired voltages between 550 mV and 1.2 V by only using two branches. Further, this saves silicon surface area.

Such alterations, modifications, and improvements are intended to be part of this disclosure, and are intended to be within the spirit and the scope of the present disclosure. Accordingly, the foregoing description is by way of example only and is not intended to be limiting.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A circuit for generating a temperature-stable reference voltage, comprising:
two terminals configured to receive a voltage:
a current source;
a first branch coupled with the current source between the two terminals and including a first resistive element and a first transistor coupled to each other; and
a second branch coupled in parallel with the first branch and coupled with the current source between the two terminals, the second branch including a second resistive element and a second transistor coupled to each other, the transistors being different from one another, and the first and second branches being coupled to each other and to the current source at a reference node configured to provide the reference voltage.

2. The circuit of claim 1, wherein the transistors are selected from among a PNP-type bipolar transistor, an N-channel MOS transistor, and a P-channel MOS transistor.

3. The circuit of claim 1, wherein the first and second transistors are MOS transistors having respective gate oxides and channel doping thickness configured to provide a desired value for the reference voltage.

4. The circuit of claim 1, wherein the resistors have respective resistance values configured to provide a desired value of the reference voltage.

5. The circuit of claim 1, wherein the transistors and resistors are configured to provide a value of the reference voltage ranging between 550 millivolts and 1.2 volts.

6. The circuit of claim 1, wherein the first transistor is an N- or P-channel MOS transistor and the second transistor is a PNP-type bipolar transistor.

7. The circuit of claim 1, wherein the first transistor is an N-channel MOS transistor and the second transistor is a P-channel MOS transistor.

8. The circuit of claim 1, consisting of the two terminals, the current source and the first and second branches.

9. A method, comprising:
forming circuit for generating a temperature-stable reference voltage, the forming including:
forming two terminals configured to receive a voltage:
forming a current source;
forming a first branch coupled with the current source between the two terminals and including a first resistive element and a first transistor coupled to each other; and
forming a second branch coupled in parallel with the first branch and coupled with the current source between the two terminals, the second branch including a second resistive element and a second transistor coupled to each other, the transistors being different from one another, and the first and second branches being coupled to each other and to the current source at a reference node configured to provide the reference voltage.

10. The method of claim 9, wherein forming the first and second branches include selecting values Ra and Rb for the first and second resistors, respectively, that comply with the following relations:
$${V}_{REF} = \frac{( 1 + α \cdot β )}{2} \cdot Ra \cdot Ia + \frac{Va + Vb}{2} ; and$$
$${V}_{REF} = \frac{1}{2} ( 1 + \frac{1}{α \cdot β} ) \cdot Rb \cdot Ib + \frac{Va + Vb}{2} ,$$
where Va and Vb are voltages across the first and second transistors, respectively, Ia and Ib are currents in the first and second resistors, respectively, and α and β are respective ratios between values Ib and Ia and between values Rb and Ra.

11. An electronic system, comprising:
an electronic device; and
a reference voltage circuit coupled to the electronic device and configured to provide a temperature-stable reference voltage to the electronic device, the reference voltage circuit including:
two terminals configured to receive a voltage:
a current source;
a first branch coupled with the current source between the two terminals and including a first resistive element and a first transistor coupled to each other; and
a second branch coupled in parallel with the first branch and coupled with the current source between the two terminals, the second branch including a second resistive element and a second transistor coupled to each other, the transistors being different from one another, and the first and second branches being coupled to each other and to the current source at a reference node configured to provide the reference voltage.

12. The system of claim 11, wherein the transistors are selected from among a PNP-type bipolar transistor, an N-channel MOS transistor, and a P-channel MOS transistor.

13. The system of claim 11, wherein the first and second transistors are MOS transistors having respective gate oxides and channel doping thickness configured to provide a desired value for the reference voltage.

14. The system of claim 11, wherein the resistors have respective resistance values configured to provide a desired value of the reference voltage.

15. The system of claim 11, wherein the transistors and resistors are configured to provide a value of the reference voltage ranging between 550 millivolts and 1.2 volts.

16. The system of claim 11, wherein the first transistor is an N- or P-channel MOS transistor and the second transistor is a PNP-type bipolar transistor.

17. The system of claim 11, wherein the first transistor is an N-channel MOS transistor and the second transistor is a P-channel MOS transistor.

18. The circuit of claim 1, wherein the current source is configured to provide a current that is proportional to temperature.
